(19) United States
(12) Patent Application Publication
(10) Pub. No.: US 2023/0379684 A1
(43) Pub. Date: Nov. 23, 2023

(54) SENSING-BASED DEVICE DETECTION

(71) Applicant: HUAWEI TECHNOLOGIES CO., LTD., SHENZHEN (CN)

(72) Inventors: ALIREZA BAYESTEH, Kanata (CA); NAVID TADAYON, Kanata (CA); JIANGLEI MA, Kanata (CA); WEN TONG, Kanata (CA)

(21) Appl. No.: 18/361,896

(22) Filed: Jul. 30, 2023

Related U.S. Application Data
(63) Continuation of application No. PCT/CN2021/075136, filed on Feb. 3, 2021.

(51) Int. Cl. H04W 8/00; H04B 1/713

(52) U.S. Cl. CPC H04W 8/005; H04B 1/713

(57) ABSTRACT

Some embodiments of the present disclosure provide for configuring devices to passively identify themselves even while not actively engaged in accessing a network. Upon receipt of a sensing signal, passive device components of a given device form a backscatter signal that is an altered version of the sensing signal. The source of the sensing signal, or an appropriately configured network node, upon receipt of the backscatter, may identify the given device by the nature of the alteration. The source of the sensing signal, or the appropriately configured network node, may then be considered to have gained information on the existence of the given device as well as a general location for the given device. The network may enlist the help of other devices to sense the environment and, by doing so, may ultimately achieve a greater degree of resolution of the sensed environment.

### RELATED APPLICATION

This application is a continuation of International Application No. PCT/CN2021/075136, filed on Feb. 3, 2021, and entitled “SENSING-BASED DEVICE DETECTION,” the disclosure of which is hereby incorporated by reference in its entirety.

### TECHNICAL FIELD

The present disclosure relates, generally, to device detection and, in particular embodiments, to sensing-based device detection.

### BACKGROUND

Mobile communication devices are increasingly ubiquitous. One feature that tends to define mobile communication devices is a rechargeable battery. It is a common feature of modern life that people go to great lengths to achieve longer battery life. From the device designer's perspective, one approach to achieve longer battery life involves increasing the capacity of the battery for a given mobile communication device. Another approach involves a power saving approach, wherein the rate of use of the power available from the battery is, in some way, reduced. The power saving approach may be regarded as more critical for low cost devices, such as different types of sensors with built-in communications.

### SUMMARY

Aspects of the present application relate to configuring devices to passively identify themselves, even while not actively engaged in accessing a network. Upon receipt of a sensing signal, passive device components of a given device form a backscatter signal that is a frequency-shifted version of the sensing signal. The source of the sensing signal, or an appropriately configured network node, upon receipt of the backscatter signal, may identify the given device by the frequency shift. The source of the sensing signal, or the appropriately configured network node, may then be considered to have gained information on the existence of the given device as well as a general location for the given device. The network may enlist the help of other devices to sense the environment and, by doing so, may ultimately achieve a greater degree of resolution of the sensed environment.

By configuring devices to passively identify themselves even while not actively accessing a network, the network can distinguish between devices and background clutter when sensing an environment. It follows that the TRP need not engage in sweeping a large number of beams over a similarly large number of different directions to facilitate initial access by individual devices. Indeed, the problem of transmitting a large number of beams may be reduced by only transmitting a relatively small number of beams, with those beams directed toward a region of the environment in which a device has been detected. The change from the beam sweeping approach to a more directed approach may be shown to reduce overhead associated with an initial access process and, consequently, reduce latency and power consumption by devices on both ends of the initial access process.

According to an aspect of the present disclosure, there is provided a method. The method includes receiving a frequency-shifted version of a sensing signal and transmitting information obtained by processing the frequency-shifted version of the sensing signal, wherein the information comprises an indication of existence of a particular device in an environment, where the particular device is associated with a particular frequency shift obtained from the frequency-shifted version of the sensing signal.

According to another aspect of the present disclosure, there is provided a method. The method includes transmitting, to a device, backscatter signal configuration information, wherein the backscatter signal configuration information includes an indication of a frequency shift. The method further includes transmitting a sensing signal, receiving a frequency-shifted version of the sensing signal, and obtaining information from the frequency-shifted version of the sensing signal. The information comprises an indication of existence of the device in an environment.

According to a further aspect of the present disclosure, there is provided a method. The method includes receiving backscatter signal configuration information, wherein the backscatter signal configuration information includes an indication of a frequency shift. The method further includes receiving a sensing signal and transmitting a frequency-shifted version of the sensing signal, based on the indication of the frequency shift.

According to a further aspect of the present disclosure, there is provided an apparatus comprising at least one processor and a non-transitory computer readable storage medium storing programming for execution by the at least one processor. The programming includes instructions to perform any the preceding methods.

According to a further aspect of the present disclosure, there is provided a non-transitory computer-readable medium having instructions stored thereon that, when executed by an apparatus, cause the apparatus to perform any the preceding methods.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates the electronic device of FIG. 3, wherein the transmitter and the receiver are combined as a transceiver that includes an RF circuit with a set of active device components and a set of passive device components, according to aspects of the present application;

FIG. 6 illustrates, in a signal flow diagram, sensing of an environment in accordance with aspects of the present application;

FIG. 7 illustrates a representation of a cyclic-prefix orthogonal frequency division multiplexing waveform on a time-frequency coordinate system;

FIG. 8 illustrates a representation of a single-carrier waveform on a time-frequency coordinate system;

FIG. 9 illustrates a representation of a fixed frequency shift on a time-frequency coordinate system;

FIG. 10 illustrates a representation of one of many time-variant frequency shifts on a time-frequency coordinate system;

FIG. 11 illustrates, in a signal flow diagram, sensing of an environment in accordance with aspects of the present application wherein sensing signals originate at a transmit receive point; and

FIG. 12 illustrates, in a signal flow diagram, sensing of an environment in accordance with aspects of the present application wherein sensing signals originate at an electronic device.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

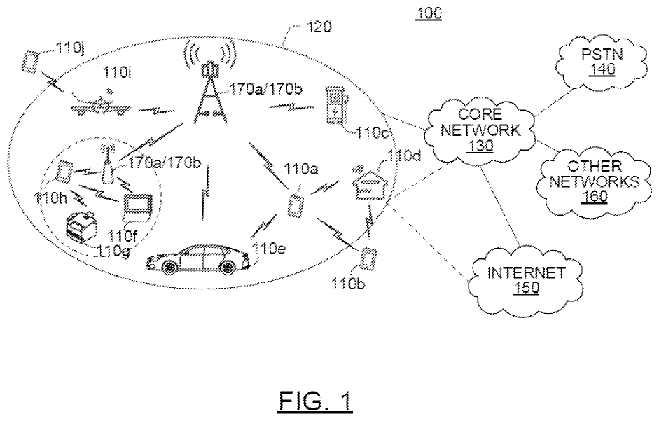

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

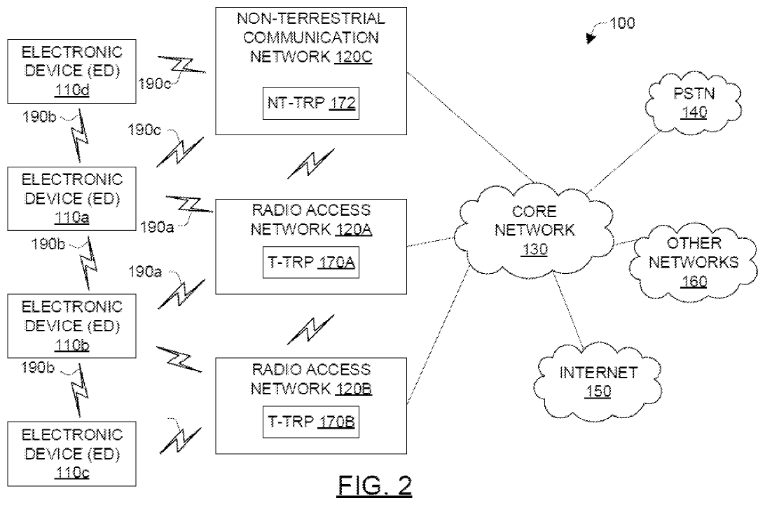

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), space division multiple access (SDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

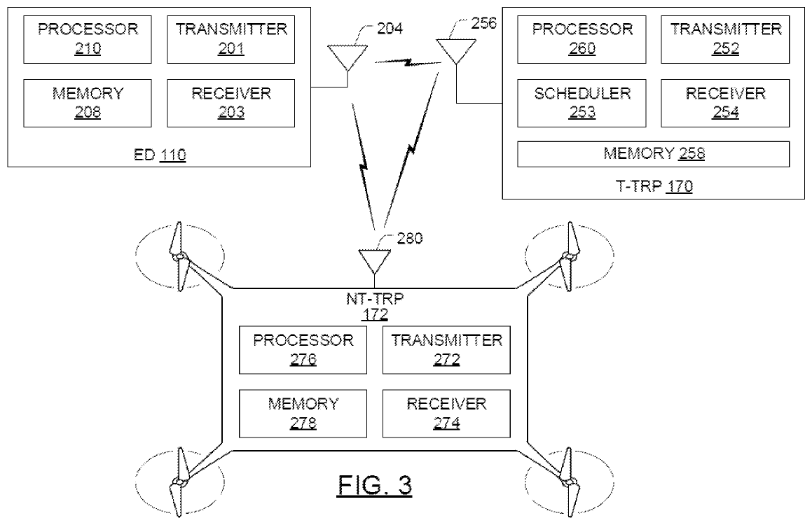

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random-access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

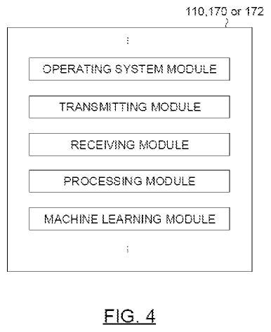

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

Further terrestrial and non-terrestrial networks can enable a new range of services and applications such as earth monitoring, remote sensing, passive sensing and positioning, navigation, tracking, autonomous delivery and mobility. Terrestrial network-based sensing and non-terrestrial network-based sensing could provide intelligent context-aware networks to enhance the UE experience. For an example, terrestrial network-based sensing and non-terrestrial network-based sensing may be shown to provide opportunities for localization applications and sensing applications based on new sets of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial networks and in non-terrestrial networks, the measured channel data and sensing and positioning data can be obtained by large bandwidth, new spectrum, dense network and more light-of-sight (LOS) links. Based on these data, a radio environmental map can be drawn through AI/ML methods, where channel information is linked, in the map, to its corresponding positioning, or environmental information, to, thereby, provide an enhanced physical layer design based on this map.

Sensing coordinators are nodes in a network that can assist in the sensing operation. These nodes can be stand-alone nodes dedicated to just sensing operations or other nodes (for example, the T-TRP 170, the ED 110, or a node in the core network 130) doing the sensing operations in parallel with communication transmissions. New protocol and signaling mechanism is needed so that the corresponding interface link can be performed with customized parameters to meet particular requirements while minimizing signaling overhead and maximizing the whole system spectrum efficiency.

AI/ML and sensing methods are data hungry. In order to involve AI/ML and sensing in wireless communications, more and more data are needed to be collected, stored and exchanged. The characteristics of wireless data are known to expand to large ranges in multiple dimensions, e.g., from sub-6 GHz, millimeter to Terahertz carrier frequency, from space, outdoor to indoor scenario, and from text, voice to video. These data are collecting, processing and usage are performed in a unified framework or a different framework.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high-altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectrum efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectrum efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or an SSB resource identifier, or a sounding reference signal (SRS) resource identifier, or other reference signal resource identifier.

RF sensing may, generally, be considered as an operation useful for characterizing background clutter in an environment. Such RF sensing may also be referred to as “passive localization” or “passive mapping.” However, in addition to detecting and characterizing background clutter objects, it may be shown that detecting and characterizing devices in the environment is also important, especially for the future networks. Currently, devices may be detected and characterized by elements of the network through an initial access mechanism. Unfortunately, this means that only those devices (such as a UE 110) that put forth an effort to access the network, that is, to connect to an element (such as a TRP 170) of the network, may be detected and characterized by the element of the network. Notably, in the future, it is expected that a given network will have many devices (UEs 110) that, in a short-term attempt to save power, do not put forth an effort to connect to the given network. These UEs 110, while they attempt to save power, may be called quiet UEs 110. It follows that non-network-accessed, yet quiet, UEs 110 may not be properly detected and characterized by elements of the given network. Note, also, that the current initial access mechanism not only demands high effort and power from the UEs 110, the current initial access mechanism also requires effort from the network element (such as a TRP 170) for beam sweeping. The effort expended by the TRP 170 results in overhead in the resource usage and increased latency.

Aspects of the present application relate to obtaining information about the existence of the quiet UEs 110. Beneficially, when a given quiet UE 110 wakes up and tries to access the network, the effort that would normally be put forth by the given quiet UE 110 for initial access, including a beam search, etc., may be minimized through the provision, to the quiet UE 110, of information about the environment in advance of the quiet UE 110 engaging in beam searching. Useful information about the environment may include a direction to aim a beam when attempting to establish a connection to a TRP 170. Furthermore, when a TRP 170 can detect that a network-registered, yet quiet, UE 110 is present in the environment, it may be shown to help to reduce an effort put forth by the TRP 170 to characterize the environment. The reduction in effort may be accomplished through various strategies, such as UE-assisted sensing strategy and a collaborative sensing strategy. Additionally, detecting that a network-registered, yet quiet, UE 110 is present in the environment may be shown to help to reduce sensing overhead and the latency associated with beam sweeping. In review, note that a given environment for a network may include a wide variety of objects. Some objects may be UEs 110. The UEs 110 are, generally, network-registered, whether the UEs 110 are actively accessing the network (connected) or the UEs 110 are not accessing the network (quiet). Some objects may be clutter. Objects that may be classified as clutter include buildings and trees. Objects that may be classified as clutter are not network-registered and have no way of accessing the network.

Typically, a TRP 170 will transmit (sweep) SSBs over a variety of beam directions to provide, to any quiet UEs 110, information about itself. Accordingly, successful localizing of quiet UEs 110 may allow the TRP 170 to minimize the transmission of SSBs. Rather than transmit SSBs in a wide variety of beam directions, the TRP 170 operating in accordance with aspects of the present application may only transmit SSBs over a small number of beam directions toward regions wherein devices have been sensed.

Notably, it is known for UEs 110 to operate in one of multiple modes or states. In a connected state, for example, the UE 110 maintains a connection with a TRP 170. When the UE 110 is in an idle state, the UE 110 is not connected to the TRP 170. By switching to an inactive state, the UE 110 conserves network resources and local power (thereby lengthening, for example, perceived battery life of the UE 110). The inactive state may be useful, for example, in those instances when the UE 110 is not communicating with the TRP 170. Notably, although the terms “connected,” “idle” and “inactive” are used here, many other names for the same, or similar, states may be used. Furthermore, in some implementations, the states may be called “modes” or other terms may be used.

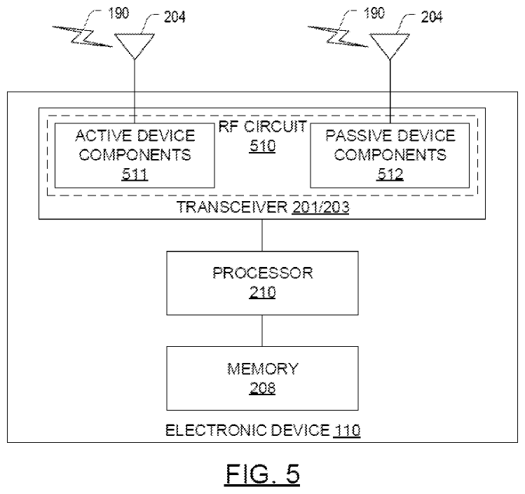

The transmitter 201 and the receiver 203, known from the illustration of the ED/UE 110 in FIG. 3 are combined, in the UE 110 of FIG. 5, as a transceiver 201/203. The transceiver 201/203 includes an RF circuit 510. The RF circuit 510 is illustrated, in FIG. 5, as including a set of active device components 511 connected to one of the antennas 204. In addition, the RF circuit 510 is illustrated as including a set of passive device components 512 connected to another one of the antennas 204.

The UE 110 configured with the passive device components 512 of FIG. 5 may be shown to perform various functions when in an idle/inactive state, without switching to a connected state. Communications between a TRP 170 and a UE 110 in an idle/inactive state may be accomplished through so-called backscattering communications.

The UE 110 may be configured to switch between using the active device components 511 and using the passive device components 512 where each set of components is functional in a different state. The UE 110 may use the active device components 511 when in the connected state, so that the UE 110 may transmit/receive data. The UE 110 may use the passive device components 512 when the UE 110 is in the idle/inactive state. Given that use of the passive device components 512 may be, at least in part, related to timing acquisition, the TRP 170 may employ an ultra-wideband signal to cause the passive device components 512 of the UE 110 to backscatter useful information. It is known that an ultra-wideband signal employs narrow beamforming toward a specified region of an environment. Narrow beamforming is known to involve effort for beam sweeping. Such effort is known to involve overhead, and one consequence of overhead is undesirable latency.

In overview, a common sensing signal is transmitted. Upon receiving and processing backscatter reflections of the common sensing signal, information may be obtained regarding the existence and approximate location of quiet devices. It is known that background clutter in an environment can make detection of devices challenging. One way to make the devices differentiable from background clutter is to arrange for the devices to backscatter the common sensing signal over different frequencies. That is, the devices may use passive device components to produce a backscattered version of the common sensing signal with an added frequency shift. Clearly, the background clutter cannot backscatter the common sensing signal in the same manner. Given that precise timing and positioning information may not be required in the initial step of detecting a quiet device, the common sensing signal can be a narrowband signal. It can be shown that use of a narrowband signal for the common sensing signal facilitates frequency hopping backscatter and subsequent detection of the backscatter. It follows that approximate position information of devices can be obtained in a spatial domain either by using massive antennas or by using collaborative processing among a plurality of devices. Subsequently, that is, once the general location of a given device is known, a further, dedicated, sensing signal may be transmitted toward the general location of the given device to obtain finer, or more precise, estimates for location and timing.

The common sensing signal may be transmitted over a base frequency, f₀. The devices may be arranged to backscatter the common sensing signal over a different frequency, that is, to transmit a frequency-shifted version of the common sensing signal. Indeed, the k^{th} UE 110 among a plurality of UEs 100 may be associated with frequency, fₖ. The passive device components 512 may be arranged to perform a frequency shift, (fₖ−f₀), on a received common sensing signal. In some embodiments, the passive device components 512 may be arranged to perform a plurality of frequency shifts, using a set of frequencies, {f_{k,i}}ᵢ₌₁^{N}, in a set of N time slots. The set of frequencies, and the pattern of frequency shifts over the time slots, may be specific to the k^{th} UE 110 and may be called a frequency hopping pattern.

In operation, in aspects of the present application and in view of a signal flow diagram illustrated in FIG. 6, the TRP 170 transmits (step 606) the common sensing signal. Upon receipt (step 608) of the common sensing signal, the passive device components 512 of the UE 110 form (step 610) CSS backscatter and transmit (step 612) the CSS backscatter. The TRP 170 then receives (step 614) the CSS backscatter. By processing (step 630) the received CSS backscatter, the TRP 170 may obtain information.

The information may include an indication of an existence of devices in a region of interest. Such an existence indication may be obtained by determining whether a signal is present over each frequency, fₖ, among a plurality of pre-established frequencies.

The information may include an indication of an approximate location for various background clutter objects and an approximate location for various devices. An indication of an approximate location for a background clutter object may be obtained by determining an angle of arrival (AoA) of the received backscatter of the common sensing signal with a zero frequency shift, that is, at the base frequency, f₀. An indication of an approximate location of the k^{th} device may be obtained by determining an AoA of the received reflections of the common sensing signal at the k^{th} frequency, fₖ or a k^{th} set of N frequencies, {f_{k,i}}ᵢ₌₁^{N}, in a set of N time slots.

The information may include an indication of an approximate location sub-space. As will be discussed hereinafter, the approximate location sub-space may be used in a next step sensing operation, which may also be called “dedicated sensing.”

Aspects of the present application relate to transmission (step 606) of a common sensing signal with a relatively narrow bandwidth. The relatively narrow bandwidth may be shown to facilitate multi-device detection at whatever device receives backscatter of the common sensing signal. In this aspect, use of a relatively narrow bandwidth common sensing signal means that timing information and positioning information may not be achieved with a desired accuracy. However, through the use of large antenna arrays or the use of using multiple receive points (devices), angle estimations may be obtained with suitable accuracy.

In some aspects of the present application, the common sensing signal transmitted in step 606 includes some information for use by UEs 110 in the environment. The information may be multi-cast information for use by some of the UEs 110. The information may be group-cast information for use by a specific group, or sub-set, of the UEs 110. The information may also be broadcast information for use by all of the UEs 110. The information may also be unicast information for a specific UE 110, in which case, the information may be carried on a dedicated data channel.

In cases wherein the common sensing signal includes information, the common sensing signal may include a DCI field. The DCI field may include a CSS indication. Through the use of the CSS indication in the DCI field, the entity transmitting the common sensing signal may indicate, to those UEs 110 that are in the connected state, that the signal received at step 608 (FIG. 6) is being used as a common sensing signal.

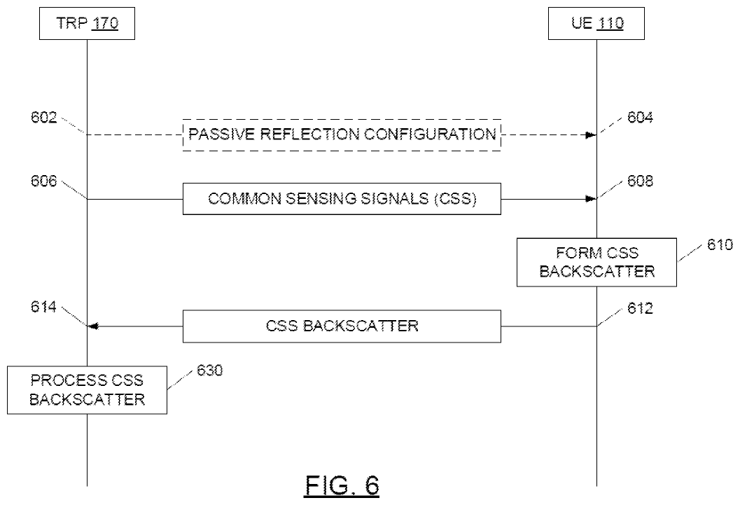

In those cases, wherein the common sensing signal includes information for use by UEs 110, a CP-OFDM waveform can be used to transmit the common sensing signal. Use of a CP-OFDM waveform may be shown to allow for simplified detection for all ranges of connected UEs 110. A representation 702 of a CP-OFDM waveform on a time-frequency coordinate system is illustrated in FIG. 7. The representation 702 includes a CSS indication 704.

In some aspects of the present application, the common sensing signal does not include any information for use by UEs 110 in the environment. In these case, the entity transmitting the common sensing signal may still communicate, to those UEs 110 that are in the connected state, that a common sensing signal is going to be transmitted. In particular, the entity transmitting the common sensing signal may use RRC signaling and any other higher layer signaling to communicate to those UEs 110 that are in the connected state.

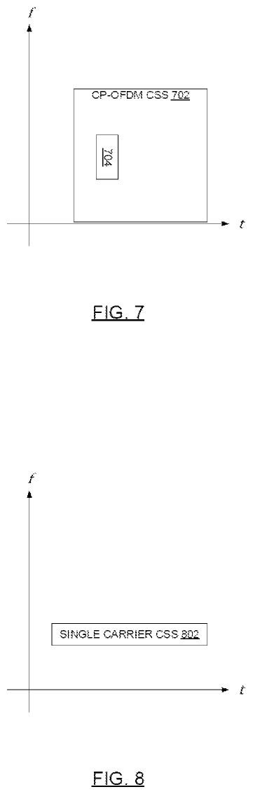

In those cases, wherein the common sensing signal does not include any information for use by UEs 110, a single-carrier waveform can be used for the common sensing signal. Use of a single-carrier waveform may be shown to allow high-power transmission and simplification of detection at the receiver side. A representation 802 of a single-carrier waveform on a time-frequency coordinate system is illustrated in FIG. 8.

Returning to FIG. 6, ahead of transmitting (step 606) the common sensing signal, the TRP 170 optionally transmits (step 602), to the UE 110, a UE-specific passive reflection configuration signal. The passive reflection configuration signal transmitted (step 602) to the k^{th} UE 110 may include an indication of a k^{th} frequency shift value, fₖ.

Among the options for frequency shift configuration, received by the UE 110 in the UE-specific passive reflection configuration signal at step 604, are a fixed frequency shift and a time-variant frequency shift.

FIG. 9 illustrates, in a time-frequency coordinate system, the fixed frequency shift option. FIG. 9 illustrates four time slots of unaltered CSS backscatter at the same frequency (a frequency shift of zero) as the common sensing signal. FIG. 9 also illustrates four time slots of frequency-shifted CSS backscatter with a first frequency shift, f₁−f₀ and four time slots of frequency-shifted CSS backscatter with a second frequency shift, f₂−f₀. An advantage of the fixed frequency shift option (FIG. 9) is simple implementation (step 610) 512 at the UE 110. However, the fixed frequency shift option has a drawback in that strong interference present at the fixed frequency may lead to failure to detect the UE 110 or falsely detect this UE 110 when processing (step 630) the received CSS backscatter.

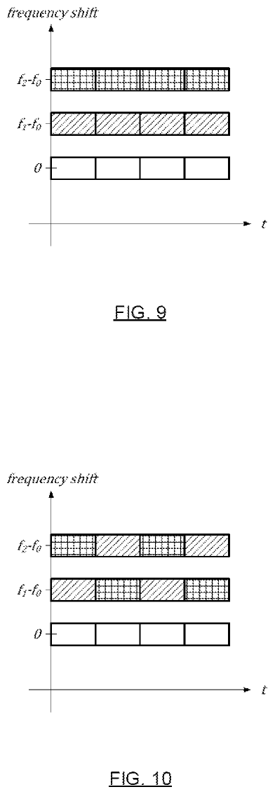

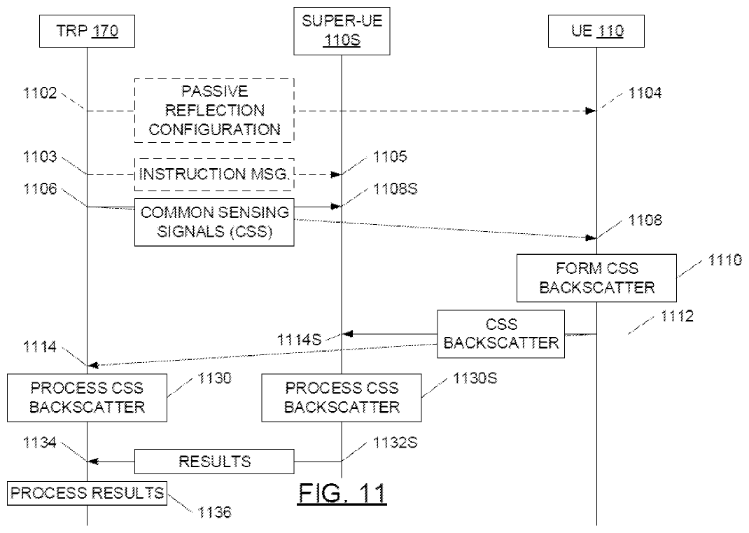

In the time-variant frequency shift option, which may also be called “frequency hopping,” a distinct frequency shift is associated with each of a plurality of time slots. FIG. 10 illustrates, in a time-frequency coordinate system, one of many time-variant frequency shift options. FIG. 10 illustrates four time slots of unaltered CSS backscatter at the same frequency (a frequency shift of zero) as the common sensing signal. FIG. 10 also illustrates four time slots wherein the frequency-shifted CSS backscatter has a first frequency shift, f₁−f₀, for the first and third time slots and has a second frequency shift, f₂−f₀, for the second and fourth time slots. FIG. 10 further illustrates four time slots wherein the frequency-shifted CSS backscatter has the first frequency shift, f₁−f₀, for the second and fourth time slots and has the second frequency shift, f₂−f₀, for the first and third time slots. Note that each of the frequency hopping patterns may be assigned/configured to a particular UE. For example, a first UE may use the first frequency hopping pattern and a second UE may use the second frequency hopping pattern. An advantage of the time-variant frequency shift option may be found in a robustness towards interference. However, the time-variant frequency shift option has a drawback of more complicated implementation (step 610) at the UE 110.

Further options for frequency shift configuration, received by the UE 110 in the UE-specific passive reflection configuration signal at step 604, include an ON-OFF pattern, wherein each UE 110 is configured to only turn ON the passive, frequency-shifting reflection (step 610 and step 612) during a subset of time slots.

Further options for frequency shift configuration, received by the UE 110 in the UE-specific passive reflection configuration signal at step 604, include a complex signature pattern, where each UE 110 is configured to form (step 610) the CSS backscatter by applying a complex symbol multiplication to the common sensing signal received in step 608 before transmitting (step 612) the CSS backscatter.

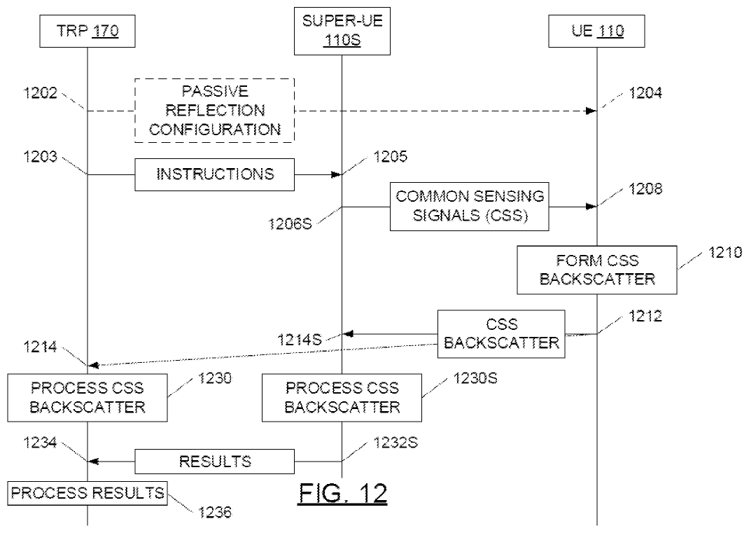

FIG. 11 illustrates a signal flow in a multi-node configuration. According to aspects of the present application, one or more network entities may assist the TRP 170 in processing the received reflected common sensing signal. The one or more network entities may include a so-called “super-UE,” a regular UE, a relay or another TRP 170. The signal flow diagram of FIG. 11 includes a super-UE 110S, however, the signal flow diagram of FIG. 11 may also apply to other entities as well. The super-UE 110 may be a UE 110 with specific qualities. One of these specific qualities is a relatively high processing capability. Another of these specific qualities is a position that is fully known to the TRP 170. The TRP 170 may select a particular UE 110 to act as the super-UE 110S to help the TRP 170 in device detection. Responsive to receiving common sensing instruction from the TRP 170, the instructed UE 110 may receive backscattered (frequency-shifted) common sensing signals and forward, to the TRP 170, information regarding signals detected or not detected at each pre-established frequency, among the received backscattered (frequency-shifted) common sensing signals, and AoA information corresponding to each detected signal.

In operation, in aspects of the present application and in view of FIG. 11, the TRP 170 transmits (step 1106) the common sensing signal. Upon receipt (step 1108) of the common sensing signal, the UE 110 forms (step 1110) CSS backscatter and transmits (step 1112) the CSS backscatter. The TRP 170 then receives (step 1114) the CSS backscatter. By processing (step 1130) the received CSS backscatter, the TRP 170 may obtain information, as discussed in conjunction with the description of the signal flow in FIG. 6 hereinbefore.

Ahead of transmitting (step 1106) the common sensing signal, the TRP 170 optionally transmits (step 1102), to the UE 110 and to the super-UE 110S, a UE-specific passive reflection configuration signal. The UE 110 may receive (step 1104) the passive reflection configuration signal and implement the configuration.

The passive reflection configuration signal transmitted in step 1102 may include an indication of time and/or frequency resources for the common sensing signal that is to be transmitted in step 1106. The indication may include a definition of duration of a time slot that is used in cases of time-variant frequency shift configuration (see FIG. 10).

The transmission (step 1106) of the common sensing signal may be performed in a sweeping manner, meaning that the TRP 170 transmits (step 1106) the common sensing signal in a particular direction at a particular time, to detect only devices in a particular region. Accordingly, the passive reflection configuration signal transmitted in step 1102 may include an indication of a periodicity of the transmission (step 1106) of the common sensing signal.

The passive reflection configuration signal transmitted in step 1102 may include an indication that the common sensing signal will include data (unicast, groupcast or broadcast). The passive reflection configuration signal transmitted in step 1102 may include an indication that the common sensing signal will not include data.

The passive reflection configuration signal may be transmitted (step 1102) using higher-layer signaling, like RRC signaling or signaling in a MAC-CE.

In the case illustrated in FIG. 11, wherein the super-UE 110S is helping the TRP 170, the TRP 170 may transmit (step 1103) an instruction message to the super-UE 110S. The TRP 170 may use layer 1 signaling or higher layer signaling to transmit (step 1103) the instruction message. In particular, the higher layer signaling may be used to transmit (step 1103) the instruction message in cases that involve a periodic UE discovery procedure or a pre-configured UE discovery procedure.

The instruction message received (step 1105), by the super-UE 110S, may also include an indication that the super-UE 110S is to perform “passive sensing.” In passive sensing, the super-UE 110S receives (step 1114S) CSS backscatter (e.g., a frequency-shifted version of the CSS transmitted by the TRP 170 in step 1106), processes (step 1130S) the CSS backscatter and transmits (step 1132S), to the TRP 170, results of the processing (step 1130S).

In some embodiments, the instruction message transmitted, by the TRP 170, in step 1103, may include an instruction indicating that the super-UE 110S is to perform “active sensing.” In active sensing, the super-UE 110S transmits common sensing signals (see FIG. 12).

The results, transmitted by the super-UE 110S in step 1132S, may include an indication of a detected frequency hopping pattern, where the frequency hopping pattern relates to the detected frequency shift in each time slot. The results, transmitted by the super-UE 110S in step 1132S, may also include an indication of the ON/OFF pattern or complex signature pattern.

The results, transmitted by the super-UE 110S in step 1132S, may also include an indication of an observed AoA of the received (step 1114S) CSS backscatter.

Upon receiving (step 1134) the results, the TRP 170 may process (step 1136) the results in the context of the information gained through the processing (step 1130) of the CSS backscatter.

Optionally, subsequent to processing (step 1136) the results, the TRP 170 may transmit (not shown), to the UE 110 and the super-UE 110S, an indication of a channel sub-space for beam search upon initial access. Such an indication may be associated with a detected frequency hopping pattern. The indication of the channel sub-space may be included in the SSB block for initial access. Also, the indication of the channel sub-space may be used, by the TRP 170, for next step sensing (e.g., dedicated sensing).

In aspects of the present application and in view of FIG. 12, the TRP 170 transmits (step 1203) an instruction message to the super-UE 110S. In some embodiments, the instruction message received (step 2105), by the super-UE 110S, may include an instruction indicating that the super-UE 110S is to perform “active sensing.” In active sensing, the super-UE 110S transmits (step 1206S) common sensing signals according to details provided in the instruction message. The TRP 170 may use layer 1 signaling or higher layer signaling to transmit (step 1203) the instruction message. In particular, the higher layer signaling may be used to transmit (step 1203) the instruction message in cases that involve a periodic UE discovery procedure or a pre-configured UE discovery procedure.

Upon receipt (step 1208) of the common sensing signal, the UE 110 forms (step 1210) CSS backscatter and transmits (step 1212) the CSS backscatter. The TRP 170 receives (step 1214) the CSS backscatter. By processing (step 1230) the received CSS backscatter, the TRP 170 may obtain information, as discussed in conjunction with the description of the signal flow in FIG. 6 hereinbefore.

Ahead of transmitting (step 1203) the instruction message to the super-UE 110S, the TRP 170 optionally transmits (step 1202), to the UE 110, a UE-specific passive reflection configuration signal. The UE 110 may receive (step 1204) the passive reflection configuration signal and implement the configuration.

The passive reflection configuration signal transmitted in step 1202 may include an indication of time and/or frequency resources for the common sensing signal that is to be transmitted, by the super-UE 110S, in step 1206S. The indication may include a definition of duration of a time slot that is used in cases of time-variant frequency shift configuration (see FIG. 10).

The transmission (step 1206S) of the common sensing signal may be performed in a sweeping manner, meaning that the super-UE 110S transmits (step 1206S) the common sensing signal in a particular direction at a particular time, to detect only devices in a particular region. Accordingly, the passive reflection configuration signal transmitted in step 1202 may include an indication of a periodicity of the transmission (step 1206S) of the common sensing signal and the instruction message transmitted in step 1203 may include an indication of a periodicity with which to transmit (step 1206S) the common sensing signal.

The passive reflection configuration signal transmitted in step 1202 may include an indication that the common sensing signal will include data (unicast, groupcast or broadcast). The passive reflection configuration signal transmitted in step 1202 may include an indication that the common sensing signal will not include data.

The passive reflection configuration signal may be transmitted (step 1202) using higher-layer signaling, like RRC signaling or signaling in a MAC-CE.

The results, transmitted by the super-UE 110S in step 1232S, may include an indication of a detected frequency hopping pattern, where the frequency hopping pattern relates to the detected frequency shifts in each time slot. The results, transmitted by the super-UE 110S in step 1232S, may also include an indication of an observed AoA of the received (step 1214S) CSS backscatter. The results, transmitted by the super-UE 110S in step 1232S, may also include an indication of the ON/OFF pattern or complex signature pattern.

Upon receiving (step 1234) the results, the TRP 170 may process (step 1236) the results in the context of the information gained through the processing (step 1230) of the CSS backscatter.

Optionally, subsequent to processing (step 1236) the results, the TRP 170 may transmit (not shown), to the UE 110 and the super-UE 110S, an indication of a channel sub-space for beam search upon initial access. Such an indication may be associated with a detected frequency hopping pattern. The indication of the channel sub-space may be included in the SSB block for initial access. Also, the indication of the channel sub-space may be used, by the TRP 170, for next step sensing (e.g., dedicated sensing).

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
receiving a frequency-shifted version of a sensing signal; and
transmitting information obtained by processing the frequency-shifted version of the sensing signal, wherein the information comprises an indication of existence of a particular device in an environment, where the particular device is associated with a particular frequency shift obtained from the frequency-shifted version of the sensing signal.

2. The method of claim 1, wherein the information further comprises an indication of an approximate location of the particular device in the environment.

3. The method of claim 1, wherein the information further comprises a detected frequency hopping pattern.

4. The method of claim 3, wherein the detected frequency hopping pattern comprises a detected frequency associated with a time slot.

5. The method of claim 3, wherein the information further comprises an observed angle of arrival corresponding to the detected frequency hopping pattern.

6. The method of claim 1, further comprising:
receiving an instruction message indicating details related to transmitting the sensing signal; and
transmitting the sensing signal.

7. A method comprising:
receiving backscatter signal configuration information, wherein the backscatter signal configuration information includes an indication of a frequency shift;
receiving a sensing signal; and
transmitting a frequency-shifted version of the sensing signal, based on the indication of the frequency shift.

8. The method of claim 7, wherein the backscatter signal configuration information includes an indication of one or more of: a frequency resource; or time slot details.

9. The method of claim 8, wherein the backscatter signal configuration information includes an instruction to apply a time-variant frequency shift to the frequency-shifted version of the sensing signal and an indication of a plurality of frequency shift values.

10. The method of claim 7, wherein the backscatter signal configuration information includes one or more of:
an instruction to apply a complex signature pattern to the frequency-shifted version of the sensing signal;
an instruction to apply an ON-OFF pattern to the transmitting of the frequency-shifted version of the sensing signal; or
an indication that the sensing signal will include data.

11. An apparatus comprising:
at least one processor; and
a non-transitory computer readable storage medium storing programming for execution by the at least one processor, the programming including instructions to cause the apparatus to perform a method comprising:
receiving a frequency-shifted version of a sensing signal; and
transmitting information obtained by processing the frequency-shifted version of the sensing signal, wherein the information comprises an indication of existence of a particular device in an environment, where the particular device is associated with a particular frequency shift obtained from the frequency-shifted version of the sensing signal.

12. The apparatus of claim 11, wherein the information further comprises an indication of an approximate location of the particular device in the environment.

13. The apparatus of claim 11, wherein the information further comprises a detected frequency hopping pattern.

14. The apparatus of claim 13, wherein the detected frequency hopping pattern comprises a detected frequency associated with a time slot.

15. The apparatus of claim 13, wherein the information further comprises an observed angle of arrival corresponding to the detected frequency hopping pattern.

16. The apparatus of claim 11, wherein the programming further includes instructions to cause the apparatus to perform the method further comprising:
receiving an instruction message indicating details related to transmitting the sensing signal; and
transmitting the sensing signal.

17. An apparatus comprising:
at least one processor; and
a non-transitory computer readable storage medium storing programming for execution by the at least one processor, the programming including instructions to cause the apparatus to perform a method comprising:
receiving backscatter signal configuration information, wherein the backscatter signal configuration information includes an indication of a frequency shift;
receiving a sensing signal; and
transmitting a frequency-shifted version of the sensing signal, based on the indication of the frequency shift.

18. The apparatus of claim 17, wherein the backscatter signal configuration information includes an indication of one or more of: a frequency resource or time slot details.

19. The apparatus of claim 18, wherein the backscatter signal configuration information includes an instruction to apply a time-variant frequency shift to the frequency-shifted version of the sensing signal and an indication of a plurality of frequency shift values.

20. The apparatus of claim 17, wherein the backscatter signal configuration information includes one or more of:
an instruction to apply a complex signature pattern to the frequency-shifted version of the sensing signal;
an instruction to apply an ON-OFF pattern to the transmitting of the frequency-shifted version of the sensing signal; or
an indication that the sensing signal will include data.
